(19) United States
(12) Patent Application Publication
(10) Pub. No.: US 2020/0318352 A1
(43) Pub. Date: Oct. 8, 2020

(54) NON-BACKED METALLIZED PET RADIANT BARRIER FACTORY BONDED TO CELLULOSIC SUBSTRATE

(71) Applicant: LOUISIANA-PACIFIC CORPORATION, Nashville, TN (US)

(72) Inventor: BRIAN ST. GERMAIN, MT. JULIET, TN (US)

(21) Appl. No.: 16/840,366

(22) Filed: Apr. 4, 2020

Related U.S. Application Data
(60) Provisional application No. 62/829,054, filed on Apr. 4, 2019.

(51) Int. Cl. E04C 2/26; B32B 7/12; B32B 21/08; B32B 21/14; B32B 27/36; B32B 38/00; B32B 37/12; E04B 2/00; E04B 1/80

(52) U.S. Cl. CPC E04C 2/26; B32B 2038/0092; B32B 21/08; B32B 21/14; B32B 27/36; B32B 38/0004; B32B 37/12; E04C 2/44; E04B 1/80; B32B 2255/205; B32B 2255/26; B32B 2311/12; B32B 2311/24; B32B 2367/00; B32B 2419/00; B32B 2607/00; B32B 2307/304; B32B 7/12

(57) ABSTRACT

A radiant barrier sheathing product formed by directly bonding an unbacked, metallized polyethylene (PET) sheet or film, or similar sheet or film, directly to a wood or cellulosic structural panel. A very thin layer of aluminum (or similar metal) is deposited via vapor deposition manufacturing processes onto one or more sides of a polyethylene sheet to form a metallized PET sheet. The elimination of the backing substrate eliminates the cost and conversion expense of producing a combined overlay product.

This application claims benefit of and priority to U.S. Provisional Application No. 62/829,054, filed Apr. 4, 2019. The complete disclosure of U.S. Provisional Application No. 62/829,054 is incorporated herein in its entirety by specific reference for all purposes.

### FIELD OF INVENTION

This invention relates to an unbacked, metallized polyethylene terephthalate (PET) sheet or film, or similar sheets or films, directly bonded to a wood or cellulosic structural panel to form an improved radiant barrier sheathing product.

### BACKGROUND OF INVENTION

Radiant barrier sheathing, typically used for roof deck and attic wall sheathing, has become a de facto standard in high solar radiation environments. Radiant barriers are installed in homes and structures, usually facing an attic space, primarily to reduce summer heat gain and reduce cooling costs. The barriers consist of a very low emissivity material that significantly limits the amount of heat that radiates from its surface. Radiant heat travels in a straight line away from any surface and heats anything solid that absorbs its energy. Most common insulation materials address conductive and convective heat flow, not radiant heat flow. In contrast, a radiant barrier reduces the radiant heat transfer from the underside of the heated roofing materials to other surfaces in the attic, thereby reducing the cooling load of the house.

Prior art radiant barriers comprise a sheathing panel or substrate with a highly reflective material adhered to the panel face facing the attic space. A layer of aluminum (typically aluminum foil) is commonly used as the reflective material, as it is, with a low emissivity of typically 0.05 or less, efficient at not transmitting radiant energy into the attic environment. Copper has an emissivity of as low as 0.02, but has a substantially higher cost and is not cost effective. In addition, both copper and aluminum tarnish or corrode over time (i.e., aged), increasing emissivity and reducing their effectiveness as a radiant barrier. Therefore, most radiant barriers will include a thin anti-oxidation coating layer to limit this effect.

The aluminum foil used in radiant barriers must be very pure to achieve a low emittance surface. The thickness of the aluminum does not affect performance; the aluminum only needs to cover the surface of the sheathing material. Typically, very thin foils (approximately 0.00025 inches thick) are used. As this foil is too thin (and thus too fragile) to be applied to wood structural panels directly, at present it is attached to another substrate, most often Kraft paper, for support. The process of attaching the thin foil to the paper is performed at a separate conversion facility, which purchases foil and paper and then bonds the two together. The combined overlay is then sold to wood structural panel producers for lamination to one side of a wood structural panel face to make the radiant barrier sheathing.

### SUMMARY OF INVENTION

In various exemplary embodiments, the present invention comprises a radiant barrier sheathing product formed by directly bonding an unbacked, metallized PET sheet or film, or similar sheet or film, directly to a wood or cellulosic structural panel. In contrast to the prior art, in several exemplary embodiments the present invention comprises a very thin layer of aluminum (or similar metal) deposited via vapor deposition manufacturing processes onto a PET sheet to form a metallized PET sheet. While the description below and attached figures discuss the sheet or film as a PET sheet or film, the material of the sheet or film also may be polyethylene, polyester, a polyolefin, similar synthetic films, or combinations thereof.

In various exemplary embodiments of the present invention, a metallized PET sheet is applied, without backing (i.e., unbacked), directly to a face of a wood structural panel substrate to produce radiant barrier sheathing. That is, no Kraft paper or similar backing substrate is used for the metallized PET sheet, the elimination of the backing substrate thereby eliminating the cost and conversion expense of producing a combined overlay product (e.g., with Kraft paper backing). In alternative embodiments, the metallized PET sheet may be laminated to Kraft paper as a backing substrate, such as at a separate conversion facility, then sold to wood structural panel producers for lamination to one side of a wood structural panel face to make the radiant barrier sheathing.

As Kraft paper and wood structural panels are both forms of cellulosic materials, bonding the Kraft paper backing to a face of the wood structural panel may be accomplished using standard adhesive materials and techniques known in the prior art. However, PET (or the other film materials described above) and wood structural panels comprise two very different materials, and thus the unbacked embodiments require a different, special adhesive to ensure a durable and robust bond. Examples of such adhesives include, but are not limited to, PVAs (polyvinyl acetates), polyurethanes, epoxies, formaldehyde bases resins (e.g., urea, phenol, melamine), cyanoacrylates, and hot melt adhesives (such as, but not limited to, ethylene-vinyl acetate (EVA) copolymers, polyolefins (PO), polyamides (PA), styrene block copolymers (SBC), or thermoplastic polyurethanes (TPU)). In some embodiments, the surface of the PET film that will be in contact with the adhesive layer optionally may be modified or treated (such as with a surface modifier or modifying layer) to help facilitate, increase and/or promote adhesion to the wood structural panel or sheathing substrate.

In one exemplary embodiment the present invention comprises a wood structural panel with an adhesive layer or coating applied to one face. A non-backed metallized PET film is then attached directly to the adhesive layer without an intervening backing layer. In some embodiments, the adhesive layer or coating may be applied to a face of the metallized film, and then applied to the face of the wood structural panel.

The adhesive layer may be applied to the face of the structural panel (or, alternatively, to a face of the metallized PET film instead of the structural panel) with a curtain coater, sprayer, or other application means known in the art, to achieve a continuous layer across the entire face of the panel (or metallized PET film) prior to adhesion or bonding of the metallized PET film with the structural panel. In the embodiment shown, the PET film has one side (opposite the side applied to the adhesive layer/face of the panel) that has been metallized with a metallized coating (which may be aluminum, copper, or similar metal, as discussed above), and the other side may be surface treated to help facilitate bonding of the PET film to the adhesive and substrate. An anti-oxidation coating or layer may be applied over the metallized layer for protection (i.e. to prevent oxidation of the metallized layer).

In an alternative embodiment, the metallized layer may be applied to the same side of the PET film that will bond to the adhesive layer (i.e., the metallized layer is disposed between the PET film and the adhesive layer). The PET film is this embodiment is clear or transparent, thereby allowing the metallized layer to be visible through the PET film. While the radiant barrier performance (i.e., low emissivity surface) may be significantly diminished in this configuration, the metallized coating will not require an anti-oxidation or other protective coating, and this configuration may thus be preferred for some applications.

In a further alternative embodiment, metallized layers may be applied to both sides of the PET film. The configuration provides a very low emissivity surface through the first metallized layer on the side of the PET film opposite the adhesive layer and the wood substrate and on the face of the finished radiant barrier sheathing product, while still allowing for a second higher emissivity surface (i.e., the second metallized layer on the side of the PET film proximate the adhesive layer and the wood substrate) underneath the clear or transparent PET film, which can still provide radiant barrier benefits should the top surface become oxidized or otherwise damaged.

### BRIEF DESCRIPTION OF THE DRAWINGS

FIG. 1 shows a view of a new radiant barrier system with a PET film with an outward-facing aluminum metallized coating in accordance with the present invention.

FIG. 2 shows a view of a new radiant barrier system with a PET film with an inward-facing aluminum metallized coating in accordance with the present invention.

FIG. 3 shows a view of a new radiant barrier system with a PET film with both faces covered by an aluminum metallized coating in accordance with the present invention.

### DETAILED DESCRIPTION OF EXEMPLARY EMBODIMENTS

In various exemplary embodiments, the present invention comprises a radiant barrier sheathing product 2 formed by directly bonding an unbacked, metallized polyethylene sheet or film 10, 12, or similar sheet or film, directly to a wood, wood-based, manufactured wood, or cellulosic panel or structural panel 20. The resulting combined overlay radiant barrier sheathing product may be stronger and lighter than, and the process eliminates the cost and conversion expense of, prior art combined overlay products.

In contrast to the prior art, in several exemplary embodiments the present invention comprises a very thin layer of aluminum (or similar metal) 12 deposited via vapor deposition manufacturing processes onto a PET sheet 10 to form a metallized PET sheet 10, 12. The thickness of the deposited metal may vary according to the particular application but is generally described as very thin, and may, in some embodiments, range from 2 to 5 microns in average thickness. While the description below and attached figures discuss the sheet or film as a PET sheet or film, the material of the sheet or film also may be polyethylene, polyester, a polyolefin, similar synthetic films, or combinations thereof.

Vapor deposition manufacturing processes include, but are not limited to, chemical vapor deposition processes, and include physical vapor deposition (PVD) processes. The latter, sometimes referred to as physical vapor transport, comprises a number of vacuum deposition methods used to produce thin films and coating, characterized by a process where the material being deposited goes from a condensed phase to a vapor phase and then back to a thin film condensed phase. The material to be coated is contained in a vacuum chamber with the source material. PVD processes include sputtering and evaporation. Examples of specific processes include the following: cathodic arc deposition (a high-power electric arc is discharged at the source material, converting some of the source material into highly ionized vapor to be deposited on the material to be coated); electron-beam PVD (the source material is heated to a high vapor pressure by electron bombardment and transported by diffusion and deposited by condensation on the cooler material); evaporation (the source material is heated to a high vapor pressure by electrical resistant heating); sputter deposition (a glow plasma discharge is directed at the source material, sputtering source material away as vapor); and pulsed laser or pulsed electron deposition (a high-power laser or pulsed electron bean ablates source material in a vapor or plasma stream).

In various exemplary embodiments of the present invention, a metallized PET sheet 10, 12 is applied, without backing (i.e., unbacked), directly to a face of a wood structural panel substrate 20 to produce radiant barrier sheathing 2. That is, no Kraft paper or similar backing substrate is used for the metallized PET sheet, the elimination of the backing substrate thereby eliminating the cost and conversion expense of producing a combined overlay product (e.g., with Kraft paper backing). In alternative embodiments, the metallized PET sheet may be laminated to Kraft paper as a backing substrate, such as at a separate conversion facility, then sold to wood structural panel producers for lamination to one side of a wood structural panel face to make the radiant barrier sheathing.

As Kraft paper and wood structural panels are both forms of cellulosic materials, bonding the Kraft paper backing to a face of the wood structural panel may be accomplished using standard adhesive materials and techniques known in the prior art.

However, PET (or the other film materials described above) and wood structural panels comprise two very different materials, and thus the unbacked embodiments require a different, special adhesive to ensure a durable and robust bond. Examples of such adhesives include, but are not limited to, PVAs, polyurethanes, epoxies, formaldehyde bases resins (e.g., urea, phenol, melamine), and cyanoacrylates. In some embodiments, the surface of the PET film that will be in contact with the adhesive layer optionally may be modified or treated (such as with a surface modifier or modifying layer 40) to help facilitate adhesion to the wood structural panel or sheathing substrate 20.

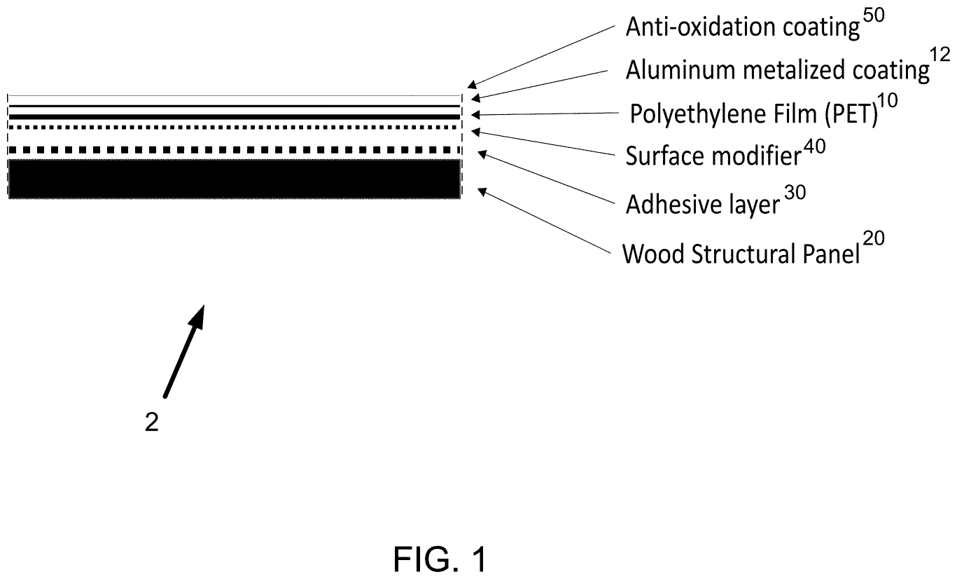

As seen in FIG. 1, in one exemplary embodiment the present invention comprises a wood structural panel 20 with an adhesive layer or coating 30 applied to one face. A non-backed metallized PET film 10, 12 is then attached directly to the adhesive layer 30 without an intervening backing layer. In some embodiments, the adhesive layer or coating 30 may be applied to a face of the metallized film 10, 12 and then applied to the face of the wood structural panel 20.

The wood structural panel 20 may comprise oriented strand board (OSB), plywood, or other wood-based product. Such panels often are approximately 4′ wide and approximately 8′ long, with thickness ranging between approximately 0.25 to approximately 1.5 inches, although other dimensions can be used depending on the application and geographic region.

The adhesive layer 30 may be applied to the face of the structural panel (or, alternatively, to the metallized PET film) with a curtain coater, sprayer, or other application means known in the art, to achieve a continuous layer across the entire face of the panel prior to application of the metallized PET film. In the embodiment shown, the PET film 10 has one side (opposite the side applied to the adhesive layer/face of the panel) that has been metallized with a metallized coating (which may be aluminum, copper, or similar metal) 12 (as discussed above), and the other side may be surface treated 40 to help facilitate bonding of the PET film to the adhesive and substrate. Typically, the non-metallized side of the PET film 10 is in contact with the adhesive layer, with the metallized layer 12 on the side of the PET film 10 opposite the wood structural panel 20, as seen in FIG. 1. An anti-oxidation coating or layer 50 may be applied over the metallized layer 12 for protection (i.e. to prevent oxidation of the metallized layer).

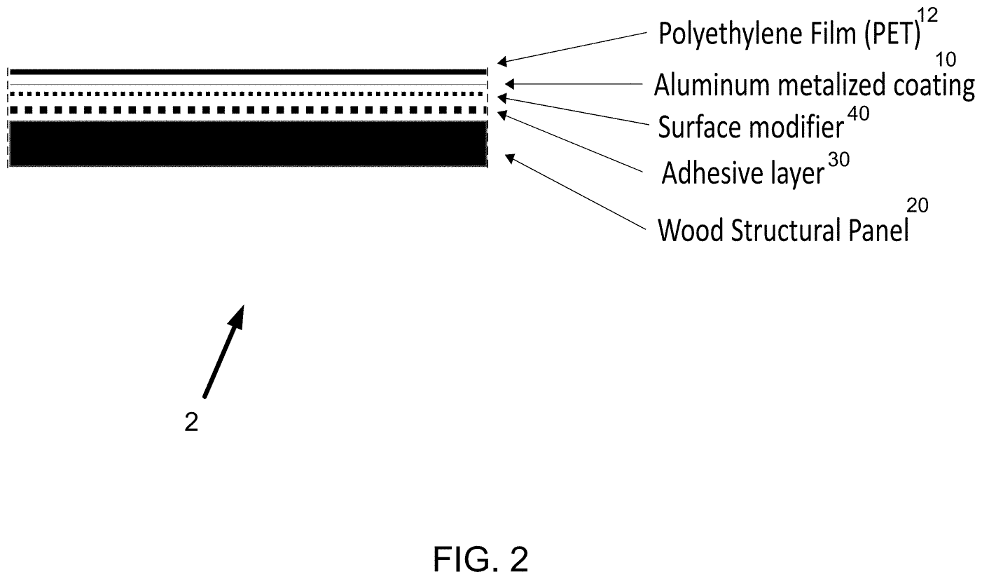

In an alternative embodiment, the metallized layer 12 may be applied to the same side of the PET film 10 that will bond to the adhesive layer 30 (i.e., the metallized layer is disposed between the PET film 10 and the adhesive layer 30), as seen in FIG. 2. The PET film 10 is this embodiment is clear or transparent, thereby allowing the metallized layer to be visible through the PET film. While the radiant barrier performance (i.e., low emissivity surface) may be significantly diminished in this configuration, the metallized coating 12 will not require an anti-oxidation or other protective coating, and this configuration may thus be preferred for some applications.

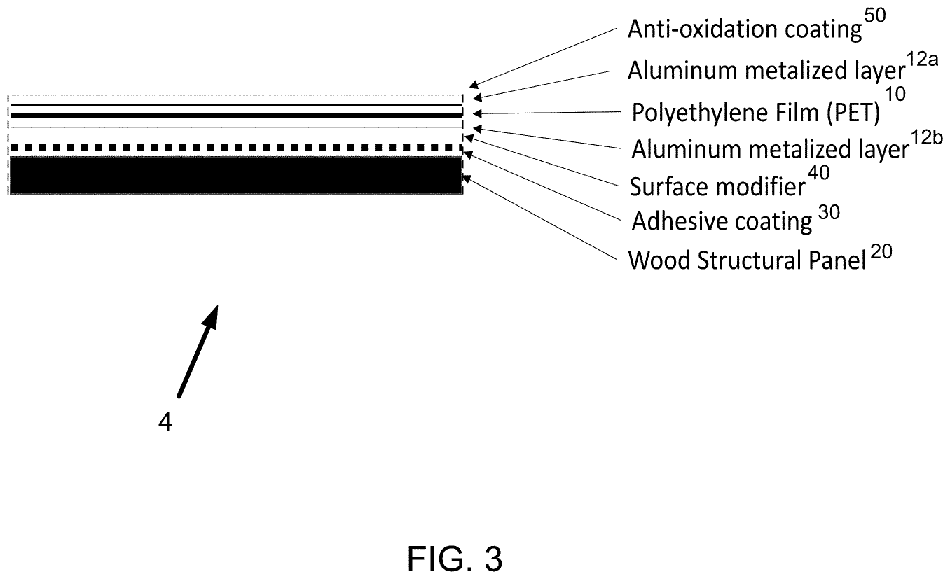

In a further alternative embodiment, metallized layers 12a, b may be applied to both sides of the PET film 10, as shown in FIG. 3. The configuration provides a very low emissivity surface through the first metallized layer 12a on the side of the PET film opposite the adhesive layer and the wood substrate 20 and on the face of the finished radiant barrier sheathing product 4, while still allowing for a second higher emissivity surface (i.e., the second metallized layer 12b on the side of the PET film proximate the adhesive layer and the wood substrate) underneath the clear or transparent PET film, which can still provide radiant barrier benefits should the top surface 12 become oxidized or otherwise damaged. The two metallized layers 12a, b may comprise the same metal, or different metals.

In one exemplary embodiment, the radiant barrier sheathing described herein is formed as follows. First, a section of OSB (oriented-strand board) is manufactured in a typical OSB production process to serve as the base material for structural panel substrates. Oriented, multilayer wood strand boards of the above-described type, and examples of processes for pressing and production thereof, are described in detail in U.S. Pat. No. 3,164,511, 4,364,984, 5,435,976, 5,470,631, 5,525,394, 5,718,786, and 6,461,743, all of which are incorporated herein in their entireties by specific reference for all purposes.

The OSB is fed through a conveyor line where a thin layer of adhesive is applied to the outer surface or face. The metallized PET film (produced by vapor deposition as described above, and shipped, typically in a roll, to the OSB manufacturing facility or a secondary manufacturing facility) is applied with a roller over the adhesive and pressed onto the OSB section. An incisor roller may be used to perforate the OSB to allow the panel to “breath” and expel excess moisture. The metallized PET film is cut as necessary, and one of more panels or desired sized are separated from, or cut or sawn from, the OSB section.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A radiant barrier sheathing product, comprising:
a wood-based substrate with a first face and a second face;
a metallized film or sheet adhesively secured to the first face of the wood-based substrate, the metallized film or sheet comprising a synthetic film or sheet with an inner side and an outer side, and a vapor-deposited layer of a metal on at least one of said inner side or said outer side.

2. The product of claim 1, wherein the synthetic film or sheet comprises polyethylene terephthalate.

3. The product of claim 1, wherein the metal comprises aluminum or copper.

4. The product of claim 1, wherein the vapor-deposited metal layer is deposited on the outer side, and the inner side is adhesively secured to the first face of the wood-based substrate.

5. The product of claim 1, where the metallized film or sheet is adhesively secured to an adhesive layer disposed on the first face of the wood-based substrate.

6. The product of claim 5, wherein the adhesive layer comprises one or more of the following: polyvinyl acetate, polyurethane, epoxy, formaldehyde base resin, cyanoacrylate, or a hot melt adhesive.

7. The product of claim 1, where the metallized film or sheet is unbacked.

8. The product of claim 1, wherein the only layer between the metallized sheet or film and the first face of the wood-based substrate is an adhesive layer.

9. The product of claim 1, wherein the vapor-deposited metal layer is deposited on the inner side, and the inner side is adhesively secured to the first face of the wood-based substrate.

10. The product of claim 1, wherein said vapor-deposited metal layer is deposited on both the inner side and the outer side.

11. The product of claim 1, further comprising a surface modifying layer disposed between the metallized film or sheet and the first face of the wood-based substrate.

12. The product of claim 11, wherein the surface modifying layer is adapted to promote adhesive bonding of metallized film or sheet to the first face of the wood-based substrate.

13. The product of claim 1, further comprising an anti-oxidation layer applied to the metallized film or sheet.

14. The product of claim 1, wherein the wood-based substrate comprise OSB or plywood.

15. A method of manufacturing a radiant barrier sheathing product according to claim 4, comprising the steps of:
manufacturing a section of OSB;
in a conveyor line, applying a layer of adhesive to a first face of the section of OSB; and
in said conveyor line, pressing a metallized PET film to the layer of adhesive on said first face.

16. The method of claim 15, further comprising the step of manufacturing said metallized PET film by vapor deposition of a metal on an outer side of a PET film.

17. The method of claim 15, further comprising the steps of:
cutting the metallized PET film; and
separating one or more panels with applied metallized PET film from the section of OSB.
